(19) United States
(12) Patent Application Publication
(10) Pub. No.: US 2026/0210432 A1
(43) Pub. Date: Jul. 23, 2026

(54) ELECTRIC-MOTOR DRIVE UNIT FOR MOTOR VEHICLE APPLICATIONS

(71) Applicant: Kiekert Aktiengesellschaft, Heiligenhaus (DE)

(72) Inventors: Winfried SCHLABS, Bochum (DE); Christian STURM, Krefeld (DE); Robert LANDSKRON, Monheim (DE)

(73) Assignee: Kiekert Aktiengesellschaft, Heiligenhaus (DE)

(21) Appl. No.: 19/138,293

(22) PCT Filed: Nov. 14, 2023
(86) PCT No.: PCT/DE2023/100872

§ 371 Date: Jun. 12, 2025

(30) Foreign Application Priority Data
Jan. 17, 2023 (DE) 10 2023 100 950.8

(51) Int. Cl. F16H 37/12; E05B 81/06; E05B 81/30; E05B 81/34; F16H 57/12

(52) U.S. Cl. CPC F16H 37/124; E05B 81/06; E05B 81/30; E05B 81/34; F16H 57/12

(57) ABSTRACT

An electric-motor drive unit is provided for motor vehicle applications and in particular to a closing-aid actuator. The drive unit has, in its basic construction, an electric motor, a gear train which is downstream of the electric motor, and an actuating element which follows the gear train. The gear train comprises at least one spur-gear gear train stage having a ring gear and having a gear which meshes with the ring gear and which rotates about a shaft. According to the invention, the shaft of the gear in question is supported on a contour of the ring gear.

The invention relates to an electric-motor drive unit for motor vehicle applications, in particular a closing-aid actuator, comprising an electric motor, a gear train downstream of the electric motor and an actuating element which follows the gear train, wherein the gear train comprises at least one spur-gear gear train stage having a ring gear and having a gear which meshes with the ring gear and which rotates about a shaft.

Electric-motor drive units for motor vehicle applications are generally characterized by operation with low-voltage direct current. For this reason, it is usually necessary to reduce the rotational movements of the electric motor using the downstream gear train. This means that small and cost-effective electric motors can also be used for energy-consuming actuation movements. These actuating movements are observed on the actuating element which follows the gear train. This actuating element can be a mechanical intermediate element which converts the rotary actuating movements of the gear train into, for example, a swivel movement or linear adjustment.

In fact, such electric-motor drive units are used in a wide variety of ways in the automotive sector and in increasing numbers. Examples of corresponding areas of application are mirror adjustments, seat adjustments, window lift devices, charging socket locks, etc. In connection with a motor vehicle lock, such an electric-motor drive unit can be used in particular as a closing-aid actuator. Then the drive unit in question works, for example, on a locking element which engages with a catch and ensures that the catch is acted upon in a closing direction.

WO2004/040089 A1 concerns the actuation of a pawl using such an electric-motor drive unit. This allows the pawl to be actuated and, in particular, to be released from its engagement with the catch. This generally causes the locking mechanism to move into its open state.

In a similar electric-motor drive unit according to DE 10 2020 121 519A1, a standard voltage motor for electromechanically actuating an actuating mechanism and, in addition, at least one low voltage motor are provided. The drive train for electro-mechanical actuation realized here is equipped with a gear train that has two gear ratios. The gear train can be designed as a spur-gear gear train.

The generic prior art according to EP 1 074 681 A1 proceeds in such a way that the motor vehicle door lock described therein is equipped with an electric drive motor which, in normal operation, operates only in one direction of rotation and with a low reduction ratio via a normal actuating element on a pawl. In emergency operation and in the opposite direction of rotation, the electric drive motor operates with a significantly higher reduction ratio via an emergency actuating element on the pawl in question. For this purpose, the reduction gear is designed as a planetary gear.

The planetary gear has a ring gear with which individual planetary gears mesh, which in turn act on an additional sun gear. The individual planetary gears are mechanically connected to each other via a planetary gear carrier. This leads to an expansive and complicated structure. The invention as a whole seeks to remedy this.

The invention is based on the technical problem of further developing such an electric-motor drive unit for automotive applications and in particular a closing-aid actuator in such a way that the greatest possible torque can be transmitted in a small installation space.

To solve this technical problem, a generic electric-motor drive unit for motor vehicle applications is characterized according to the invention in that the shaft of the gear meshing with the ring gear is supported on a contour of the ring gear. The shaft of the ring gear is preferably supported both axially and radially with the help of the contour.

In this way, at least one gear train stage or spur-gear gear train of the gear train is initially equipped with the ring gear and the gear meshing therein. The gear train stage in question is usually the last gear train stage of the gear train, i.e., the one which operates on the output side of the gear train on the actuating element actuated thereby. In addition, the observed torque is greatest on this last gear train stage.

Because the gear train stage in question is designed according to the invention in such a way that a gear meshes with the ring gear and both the ring gear and the gear meshing with the ring gear rotate about a shaft, the ring gear and the gear can be arranged with a small axial distance from each other. In any case, the axial distance of the two shafts running parallel to each other, on the one hand of the ring gear and on the other hand of the gear which meshes with the ring gear, is smaller than the center distance which is observed when the gear in question does not mesh with the ring gear, but rather meshes with an external toothing of the ring gear.

The ring gear is usually directly or indirectly coupled to the actuating element. This already provides a particularly compact structure. In this case, the adjusting element can be designed as an attachment that can be connected to or is connected to the ring gear and which corresponds in size to the ring gear. A flexible connection means, such as a cable pull, can then be connected to the corresponding attachment. The cable pull can be used to close a locking mechanism of a motor vehicle lock that is located remote from it. For this purpose, the cable pull may be mechanically coupled from the attachment directly to a catch or indirectly via intermediate elements to the catch in order to act upon it in the pre-ratchet position of the locking mechanism in a closing direction.

The compact design is now facilitated according to the invention in that the gear meshing with the ring gear and driving the ring gear does not protrude laterally beyond the ring gear. Nevertheless, a high torque can be transmitted, which in the example described is used to actuate the cable pull connected to the attachment.

Because the ring gear and the pot-or lid-like attachment are usually coupled to each other in a rotatably fixed manner, while the gear which meshes with the ring gear performs a rotational movement along the internal toothing in the ring gear, it is generally necessary to support the shaft of the gear meshing with the ring gear, which shaft is free in the direction of the attachment. According to the invention, this is ensured by the contour of the ring gear, on which contour the shaft of the gear which meshes with the ring gear is supported. The additional guide ensures that the shaft of the driving gear meshing with the ring gear is normally perfectly guided and held on both sides, both radially and axially.

The previously mentioned contour of the ring gear ensures the guidance of the free end of the shaft or a guide pin provided at this point. The opposite end of the shaft or the guide pin of the gear, on the other hand, is generally connected to another gear, or the guide pin for both gears can, for example, be supported against a housing that accommodates the electric-motor drive unit. The housing may be of modular construction, so that the electric-motor drive unit can be arranged according to the invention and placed in practically any location, for example inside a motor vehicle door. The actuating movements provided by the electric-motor drive unit are transmitted via the attachment which rotates together with the ring gear to the cable pull and in particular the Bowden cable detachably connected to the attachment.

Using the cable pull or Bowden cable, the desired elements in or on the motor vehicle can then be moved. This can be, without limitation, the catch of a locking mechanism in order to implement a closing-aid actuator in this way. In principle, however, any other actuating movement can also be realized using the electric-motor drive unit according to the invention, for example the previously mentioned mirror adjustment, a seat adjustment, a window movement, etc.

In order to realize and implement this in detail, the contour of the ring gear is generally annular for supporting the free shaft of the gear in particular. In addition, the design is usually such that the contour in question and the ring gear are arranged concentrically to a common shaft. The cup-shaped attachment is also generally arranged concentrically to this common shaft and is connected to the ring gear in a rotatably fixed manner.

In addition, the design is advantageously such that the contour is arranged at a distance from the gear rim of the ring gear inside the ring gear. In particular, the gear which meshes with the ring gear having the guide pin defining the shaft ensures that the guide pin in question slides along the contour of the ring gear in a rotating manner. In this context, the design is also such that the guide pin engages over the gear on the head side. This allows the guide pin, which is typically located in the center of a gear rim of the gear, to engage over the gear rim of the gear meshing with the ring gear. As a result, the design is particularly advantageous in such a way that the contour at least partially engages over the gear rim in question.

This means that the guide pin defining the shaft of the gear meshing with the ring gear projects with its head-side end over the gear rim of the gear. As a result, the head-side end of the guide pin can interact with the contour of the ring gear and, in particular, can slide along the contour in question in a rotating manner during a rotational movement of the gear meshing with the ring gear. At the same time, the design is advantageously such that the contour, due to the projecting nature of the free end of the guide pin, at least partially engages over and also can engage over the gear rim of the gear meshing with the ring gear. This provides additional axial locking for the guide pin and with it the gear meshing with the ring gear. This is because the gear rim of the gear moves during its rotational movement along the internal toothing of the ring gear, as it were, “under” the contour of the ring gear, which toothing at least partially engages over the gear rim.

A cost-effective and at the same time weight-optimized embodiment is then further characterized by the fact that the contour and the ring gear are made of the same material. This is also true for the pot-like attachment. Overall, a one-piece design of the attachment including the ring gear and contour made of plastics material has proven to be particularly advantageous. The gear that meshes with the ring gear and the other gears of the gear train downstream of the electric motor can also be made of plastics material.

The individual spur gears of the intermeshing gears of the gear train may mesh with each other via spur gearing or helical gearing. Combinations are also conceivable. In most cases, the design is such that a total of two spur-gear gear train stages of the gear train are provided. While the first gear train stage for transmitting rotary movements of a worm on an output shaft of the electric motor is equipped with helical gearing in order to suppress any noise originating from the electric motor and to minimize running noise, the subsequent second gear train stage, in contrast, is equipped with straight teeth. This following gear train stage is the final or last gear train stage of the gear train, which is equipped with the ring gear and the driving gear meshing therewith.

This makes it possible to provide and realize particularly high overall gear ratios or overall reduction ratios, which provide values of more than 100:1, and in particular even more than 300:1. As a result, it is possible to work with a small and particularly cost-effective electric motor which, even in conjunction with a closing-aid actuator, provides the forces required for the closing function. As a result, a conventional electric motor, such as that which has previously been used typically inside motor vehicle locks for (central) locking functions, is used as the electric motor.

As a result, an electric-motor drive unit for automotive applications and, in particular, a closing-aid actuator is provided which has a compact and at the same time cost-effective design but nevertheless provides a high torque on the output side, which torque is used to provide even the forces required for a closing function. This can ultimately be explained by the combination of the ring gear with the driving gear meshing therewith in connection with the last gear train stage, wherein the contour of the ring gear also ensures that the shaft of the gear is supported on the relevant contour of the ring gear. This applies in particular to a free end of the gear shaft or the part of the guide pin that engages over the gear rim of the gear on the head side.

The invention is explained in greater detail below with reference to drawings which show only one exemplary embodiment. In the drawings:

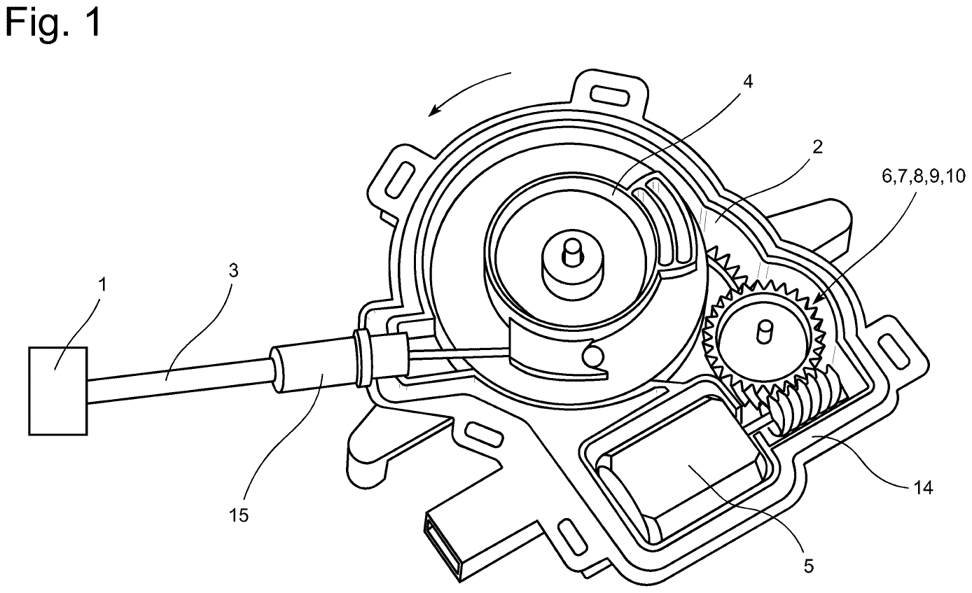

FIG. 1 shows the electric-motor drive unit according to the invention in a perspective overview with the housing partially opened,

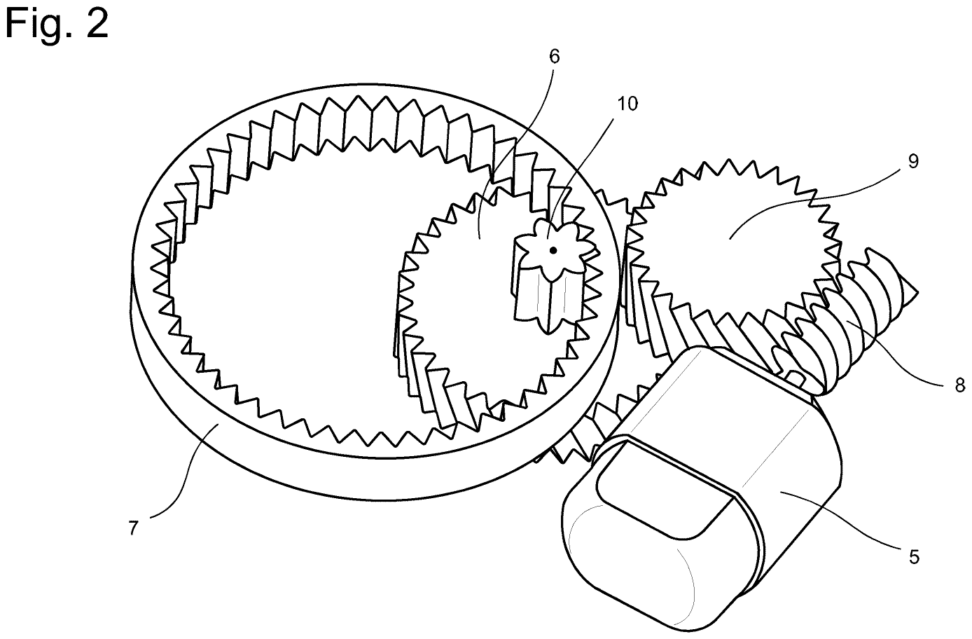

FIG. 2 shows the subject according to FIG. 1 in the region of the electric motor including the gear train in detail and

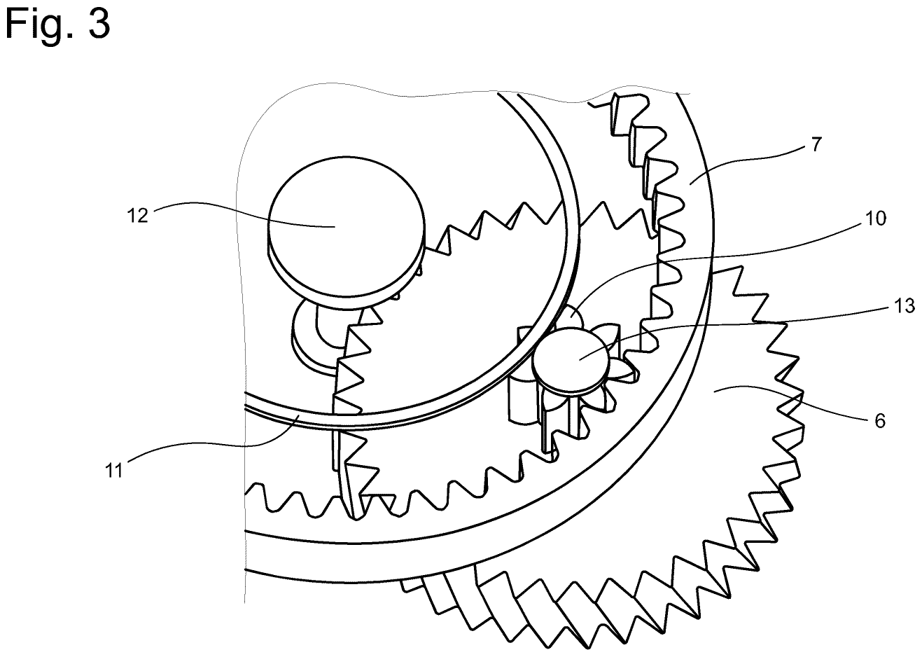

FIG. 3 shows a detail from FIG. 2 with the ring gear provided according to the invention including the annular contour provided thereon.

In the figures, an electric-motor drive unit for motor vehicle applications is shown. With the aid of the drive unit shown in FIG. 1 in an overall overview, it is possible, for example, to act on a motor vehicle lock 1, which is only indicated here and is arranged remotely from the electric-motor drive unit. The motor vehicle lock 1 is equipped inside with a locking mechanism (not shown), which can be closed by means of the electric-motor drive unit according to FIG. 1. To do this, the locking mechanism is first moved into a pre-ratchet position and then closed using the electric-motor drive unit shown. For this purpose, the drive unit in question operates, by way of example and not restrictively, on a catch as a component of the locking mechanism inside the motor vehicle lock 1. This is described in detail in DE 10 2013 108 156 A1 , which is cited as a reference by way of example.

The electric-motor drive unit according to FIG. 1 is equipped overall with an enclosing housing 2, which has or can have a housing lower shell shown here and a housing upper shell closing the housing lower shell. This means that the drive unit can be installed modularly and in virtually any location, for example inside a motor vehicle door. In the exemplary embodiment, the mechanical coupling between the drive unit and the motor vehicle lock 1 is provided by a cable pull 3, which is or can be designed as a Bowden cable. With the aid of the cable pull 3, linear adjustment movements can be transmitted to the motor vehicle lock 1, which can be used to transfer the catch of the locking mechanism from a pre-ratchet position to a main ratchet position, comparable to the previously mentioned state of the art according to DE 10 2013 108 156 A1.

Of course, this applies only by way of example and is in no way restrictive. This means that in addition to the illustrated embodiment of the electric-motor drive unit as a closing-aid actuator, other actuating movements can of course also be implemented with the drive unit in question. For this purpose, the drive unit is equipped with an actuating element 4, which, according to the exemplary embodiment and not restrictively, is an attachment 4. From FIG. 1 it can be seen that the cable pull 3 is inserted with one end of its cable into a recess of the actuating element 4 or attachment 4. As a result, rotational movements of the attachment 4 in the clockwise direction indicated here in FIG. 1 result in the cable of the cable pull 3, for example, pulling on the catch inside the motor vehicle lock 1 and transferring it from the pre-ratchet position to the main ratchet position.

In order to implement and realize this in detail, the drive unit previously shown in the overview according to FIG. 1 is equipped with an electric motor 5. A gear train 6, 7, 8, 9, 10 is downstream of the electric motor 5. For this purpose, the electric motor 5, via a worm 8 arranged on its output shaft, operates on an intermediate gear 9, which according to the embodiment is designed as a double gear 9 and meshes with a first gear train stage 6. The first gear train stage 6 is again designed as a double gear and has a gear 10 meshing with a ring gear 7.

It can be seen that the gears 6, 7, 9, 10 are all designed as spur gears, and consequently the gear train 6, 7, 8, 9, 10 is designed as a spur-gear gear train. The ring gear 7 provided within the final or last or second gear train stage 7 is now coupled in a rotationally fixed manner to the previously mentioned attachment 4 as an actuating element 4. As a result, rotational movements of the ring gear 7 directly result in the attachment 4 being acted upon, for example, performing the counterclockwise movement shown in FIG. 1, so that with the aid of the attachment or actuating element 4, the cable pull 3 is subjected to a pulling force as described.

It can be seen that the worm 8 as well as the intermediate gear 9 and the first gear train stage 6 each have helical gearing. This provides a noise-optimized gear train path from gears 6 to 10. In contrast, the last or second gear train stage 7 on the output side is equipped with a spur gear. Furthermore, the design in this context is such that the spur-gear gear train stage or last gear train stage 7 is equipped with the ring gear 7 and the gear 10 which meshes with the ring gear 7 and which rotates about a shaft. This already provides a compact structure because the gear 10, for example, does not mesh externally with a toothing of the ring gear 7. In addition, the ring gear 7 can be arranged and placed in overlap with the first gear train stage 6 or the double gear 6 realized at this point. This also results in a particularly compact structure, which can be seen in FIG. 1. This is because the attachment or the actuating element 4 is connected to the ring gear 7, which in the exemplary embodiment is designed in the shape of a disk or pot and whose dimensions correspond to those of the ring gear 7.

In this way, the areal extent of the housing 2 for accommodating the electric-motor drive unit according to the invention is ultimately determined and specified only by the external dimensions of the electric motor 5, the intermediate gear 9 and finally the ring gear 7. This leads to the small and compact design already described. This is further enhanced by the fact that rotational movements of the output shaft of the electric motor 5 or its output-side worm 8 can be reduced by the selected gear train design, taking into account a reduction ratio of more than 100:1, in particular even more than 300:1. As a result, a small-sized, cost-effective electric motor 5 that is available in large quantities, as already described in the introduction, can be installed.

According to the invention and as shown in FIGS. 2 and 3, the design is such that the shaft of the gear 10 is supported entirely on a contour 11 of the ring gear 7, which has been omitted from the illustration in FIG. 2 for reasons of clarity, but is expressly shown in FIG. 3. This means that the ring gear 7 is additionally equipped with the contour 11 in question in an intermediate region between the outer peripheral toothing and a central region 12 defining the shaft of the ring gear 7. The contour 11 now serves to support the shaft of the gear 10 meshing with the ring gear 7.

In fact, for this purpose, the gear 10 is equipped with a guide pin 13, which can be seen in particular in FIG. 3 and which engages over a gear rim of the gear 10 on the head side. The guide pin 13 not only defines the shaft of the gear 10 which meshes with the ring gear 7, but also the shaft of the gear 6 which interacts with the gear 10 and functions as a continuous guide pin 13 for the double gear 6, 10 realized at this point.

The guide pin 13 in question can be supported on the base side on a housing shell or a corresponding receiving bore in the lower housing shell shown in FIG. 1. The upper end of the guide pin 13 and thus also of the shaft of the gear 10 meshing with the ring gear 7 is, however, free. In order to nevertheless realize and implement a perfect guidance of the shaft of the gear 10 and thus of the guide pin 13 at this point, the contour 11 is provided on the ring gear 7. In this context, the contour 11 ensures axial and radial support of the guide pin 13 and thus of the shaft of the gear 10.

It can be seen that the contour 11 has an annular design. In fact, the contour 11 as well as the ring gear 7 are each arranged concentrically to the common shaft, which runs centrally through the central element or the central region 12 of the ring gear 7. In addition, the contour 11 in question is arranged at a distance from the gear rim of the ring gear 7 in the interior of the ring gear 7.

The guidance of the gear 10 meshing with the ring gear 7 is now carried out via the guide pin 13, which slides along the contour 11 in question in a rotating manner. This results in a radial bearing of the guide pin 13. In this case, the design is additionally such that the guide pin 13 engages over the gear 10 in question or a gear rim realized at this point on the head side. In this context, the guide pin 13 is arranged in the center of the previously described gear rim of the gear 10. As a result, the gear 10 in question is additionally supported axially.

An examination of FIG. 3 makes it clear that the contour 11 of the ring gear 7 at least partially engages over the gear rim in question of the gear 10. This can be attributed to the fact that the guide pin 13 not only engages over the gear rim in question on the head side, but is also equipped with a diameter opposite to which the individual teeth of the gear rim of the gear 10 protrude. As a result, the contour 11 can engage over at least two teeth of the relevant gear rim of the gear 10 meshing with the ring gear 7. In this way, the gear 10 in question is additionally secured axially.

This means that the contour 11 of the ring gear 7 not only ensures guidance or radial support of the gear 10 meshing with the ring gear 7 along the contour 11, but also ensures that the guide pin 13 or the gear 10 in question is secured axially between, on the one hand, a bearing point (not shown) in the lower housing shell of the housing 2 and, on the other hand, by the engagement of individual teeth on the underside of the contour 11 in the relevant axial direction.

For reasons of simple and cost-effective production, the contour 11 and the ring gear 7 are generally made of the same material, for example plastics material. This is also true for the other gears of the gear train 6, 7, 8, 9, 10. It is understood that the housing 2 can, if necessary, house the illustrated electric-motor drive unit in a media-tight manner, which can be ensured by a seal (not shown) inserted into a groove 14 of the lower housing shell of the housing 2 shown in FIG. 1. This means that the entire electric-motor drive unit can be installed as a modular closing-aid actuator, for example in the so-called wet space inside a motor vehicle door. At the same time, in such a case the cable pull 3 is introduced into the housing 2 in question via a sealing grommet 15 in order to ensure the media-tight design. According to the invention, this modular character is combined with a high reduction ratio, a compact design and a particularly cost-effective embodiment, which, overall and in summary, are the essential advantages.

### LIST OF REFERENCE SIGNS

Motor vehicle lock 1
Housing 2
Cable 3
Attachment 4
Actuating element 4
Electric motor 5
Gear train 6, 7, 8, 9, 10
Gear train stage 6
Gear train stage 7
Ring gear 7
Worm 8
Intermediate gear 9
Double gear 9
Gear 10
Contour 11
Central region 12
Guide pin 13
Slot 14
Sealing grommet 15

1. An electric-motor drive unit for motor vehicle applications, in particular a closing-aid actuator, comprising an electric motor, a gear train downstream of the electric motor and an actuating element which follows the gear train, wherein the gear train has at least one spur-gear gear train stage with a ring gear and a gear meshing with the ring gear and which rotates about a shaft,
wherein
the shaft of the gear is supported on a contour of the ring gear.

2. The drive unit according to claim 1, wherein the contour is designed with an annular shape.

3. The drive unit according to claim 1, wherein the contour and the ring gear are arranged concentrically to a common shaft.

4. The drive unit according to claim 1, wherein the contour is arranged at a distance from a gear rim of the ring gear in the interior of the ring gear.

5. The drive unit according to claim 1, wherein the gear meshing with the ring gear slides along the contour in a rotating manner with a guide pin.

6. The drive unit according to claim 5, wherein the guide pin engages over the gear on the head side.

7. The drive unit according to claim 5, wherein the guide pin is arranged in the center of a gear rim of the gear.

8. The drive unit according to claim 7, wherein the contour of the ring gear at least partially engages over the gear rim of the gear.

9. The drive unit according to claim 1, wherein the contour and the ring gear are made of the same material.

10. The drive unit according to claim 1, wherein the actuating element is designed as a preferably hood-like or pot-like attachment which is coupled to the ring gear in a rotatably fixed manner.
